(19) United States
(12) Patent Application Publication
(10) Pub. No.: US 2021/0371089 A1
(43) Pub. Date: Dec. 2, 2021

(54) METHOD AND MEANS OF POWERED LIFT

(71) Applicant: TELEDRONE LTD., Ware Hertfordshire (GB)

(72) Inventor: Colin Hilton, Lancashire (GB)

(73) Assignee: TELEDRONE LTD., Ware Hertfordshire (GB)

(21) Appl. No.: 17/048,294

(22) PCT Filed: Feb. 18, 2019
(86) PCT No.: PCT/GB2019/050426

§ 371 Date: Oct. 16, 2020

(30) Foreign Application Priority Data
Feb. 17, 2018 (GB) 1802611.2
Feb. 23, 2018 (GB) 1802918.1
Oct. 18, 2018 (GB) 1816965.6
Dec. 6, 2018 (GB) 1819915.8
Dec. 20, 2018 (GB) 1820780.3

(51) Int. Cl. B64C 27/08; B64C 39/02

(52) U.S. Cl. CPC B64C 27/08; B64C 39/024; B64C 2201/128; B64C 2201/042; B64C 2201/108; B64C 2201/027

(57) ABSTRACT

A multicopter (10) is disclosed, which has fuselage (12) and a lift structure (14). The fuselage (12) is suitably a stand-within structure for a single occupant (50), or a harness (120) which connects the occupant (50) to the lift structure (14). The lift structure (14) is formed from a plurality of spars (16) that extend outwardly from the fuselage. Each spar (16) carries, at their distal ends (22), a rotor (24) which provides thrust and/or lift for the multicopter (10). The lift structure (14) includes four or more spars (16) arranged so as to define a central aperture (18) within which the fuselage and/or occupant (50). The lift structure (14) may be moveable relative to the fuselage (12) so that the centre of lift can be moved relative to the centre of gravity, which can facilitate a transition between ground effect and normal flight, as well as reducing the structural requirements of the fuselage (12).

The invention relates to powered-lift devices that are suitable for use, or adaptation, as personal transport devices.

In recent years, a need has become apparent to develop transportation devices to alleviate traffic on roads and/or to provide improved and/or more convenient methods of people travelling between two points. It is envisaged that the invention described herein might be of particular benefit in congested urban transportation areas, as well as other possible applications, such as delivering people to/from remote locations that do not have road access and the like.

It has been proposed to use small aircraft for this purpose, but the majority of commercially-available small or single-seat aircraft do not lend themselves well to “short field” take offs and landings. In addition, it takes a considerable amount of time and effort to learn the skills necessary to pilot a conventional aircraft, which means that the use of conventional aircraft for general-population, single-person, point-to-point delivery is unfeasible. This invention aims to provide a solution to one or more of the above problems or to provide an improved and/or alternative method for transporting people between places.

With recent developments in computer processing power and brushless electrical motors, beside improvements in electrical storage devices, environmental powered-lift devices are about to make a breakthrough in the realm of personal intra-urban transportation.

Nonetheless the layout of many such machines is conventional in outward appearance, as indeed the earliest motor-cars rarely differed from the horse-drawn carriage. For instance, invariably they feature a seat whereas for the millions of commuters using rapid-transit systems, a seat is more often a luxury than a necessity. For most point-to-point journeys a seat is pointless, as are conventional flight controls when trajectory is wholly controlled using communications with a chip.

A need therefore exists for a new type/design of aircraft, which is simpler, smaller and more lightweight than existing aircraft, and/or one which is also safer and easier to operate.

Aspects of the invention are set forth in the appended independent claim. Preferred or optional features of the invention are set forth in the appended dependent claims.

According to one aspect of the invention, there is provided a multicopter comprising a fuselage and a lift structure, the lift structure being formed from a plurality of spars extending outwardly from the fuselage and carrying, at their distal ends, a rotor which provides thrust and/or lift for the multicopter, characterised in that the lift structure comprises four or more spars arranged so as to define a central aperture.

In the context of this disclosure, a “multicopter” that is aircraft similar to a drone or helicopter in operation and/or appearance, which has a plurality of rotors that rotate to create downwardly-directed thrust. Specifically, this invention suitably uses electric motor-driven rotors, which direct their wash downwardly so as to produce lift. Because a multicopter has more than one rotor, it is possible not only to produce lift, but also forward and lateral movement by adjusting the relative speeds of the rotors. Such technology is already well-known from multicopter drones in which movement of the drone at all six axes is possible by computer control of the rotor speeds. The six possible axes of movement are, of course, up/down, left/right, forward/backwards, roll, pitch and yaw.

Any number of rotors may be provided, although there are certain advantages associated with having four or more rotors, for example redundancy and easier control algorithms. The lift structure of the invention is formed from a plurality of spars that extend outwardly from the fuselage. The rotor or rotors is/are provided at, or near to, the distal ends of each spar. Such a configuration means that there is a plurality of rotors arranged around a central fuselage, which means, in turn, that the thrust is distributed around the centre of gravity of the multicopter. Therefore, it is possible to manoeuvre the multicopter in all six axes by varying the speeds of the rotors.

The spars may be manufactured from any material, although it is envisaged that carbon-fibre, or extruded metal spars would be preferred. Suitably, the spars are formed from lengths of lightweight aluminium extrusions, which have relatively high specific bend strength as well as a relatively high specific torsional strength. This means that the orientation of the rotors relative to the fuselage can be fixed, in certain embodiments. By providing a relatively rigid structure thus, it is possible to reduce or eliminate unwanted “thrust vectoring” due to unintended twisting/bending of the spars.

The spars of the lift structure are configured so as to form a central aperture. The central aperture is useful as it enables a payload, for example, a passenger and/or the fuselage, to be mounted/located centrally therein.

Each spar suitably comprises a root end opposite to the distal end, the four or more spars being interconnected such that the root end of a first one of the spars is fixed relative to a fixing point of another spar, which fixing point is located between the root end and the distal end of the said other spar.

In certain embodiments of the invention, the root end of one spar is fixed or affixed to a fixing point of another spar. This can be accomplished in a variety of ways, such as by bolting/screwing the spars together, by using adhesives and/or by forming the lift structure as a unitary component. However, it is envisaged that welding of the root end of one spar to the fixing point of the other would be the preferred method of forming the joint, as it provides a reliable and lightweight connection between the two components.

Another aspect of the invention provides a multicopter comprising a fuselage and a lift structure, the lift structure being formed from a plurality of spars extending outwardly from the fuselage and carrying, at their distal ends, a rotor which provides thrust and/or lift for the multicopter, characterised in that the lift structure comprises four or more spars arranged so as to define a central aperture, in which each spar comprises a root end opposite to the distal end, the four or more spars being interconnected such that the root end of a first one of the spars is fixed relative to a fixing point of another spar, which fixing point is located between the root end and the distal end of the said other spar.

Suitably the lift structure comprises four spars, which are arranged at right angles to one another. The aperture may be substantially square-shaped or substantially rectangular-shaped.

Suitably the fuselage is located within the aperture. Preferably, the fuselage has a substantially prismatic shape whose substantially constant cross-section nests within the aperture. The lift structure may thus be moveable relative to the fuselage between lower and upper positions.

Because the lift structure has a central aperture, this means that the fuselage can be located/nested in that aperture. If there is clearance between the aperture and the fuselage, it is therefore possible for the lift structure to be slideable relative to the fuselage.

In the context of this disclosure, the fuselage suitably has a prismatic-shaped cross-section, which cross-section corresponds to the internal shape of the aperture formed in the lift structure. For example, if the aperture is square-shaped, then the cross-section of the fuselage would be a slightly smaller square than the aperture defined by the lift structure.

The advantage of being able to move the lift structure relative to the fuselage is that it is possible to change the position of the centre of lift relative to the centre of gravity of the multicopter. The offset can be fixed, or adjusted at different points in time.

For example, when the multicopter is on the ground, it is possible to lower the lift structure such that entry/egress into/from the multicopter is facilitated because the lift structure is not located at, or above, head height. In addition, this configuration not only lowers the overall centre of gravity of the multicopter, making it more stable on the ground; but also means that the strength of the fuselage does not need to be designed so as bear the weight of the lift structure when it is not in-flight. As the multicopter will spend most of its time on the ground, it makes sense to configure it thus so that the weight of the structure can be reduced. Specifically, by making the structure lowerable to ground level when the multicopter is not in-flight, it is possible to reduce the strength/weight requirement of the fuselage, thereby increasing the overall efficiency of the multicopter in flight.

Another possible benefit of being able to move the centre of lift relative to the centre of gravity is aerodynamic. For example, if the multicopter is going to be flown at a low height, specifically in “ground effect”, then it is useful to be able to lower the centre of lift, that is, by keeping the lift structure towards the bottom of the fuselage, so that benefits of ground effect are maximised by moving the rotors as close as possible to the ground. That said, having the centre of lift located below the centre of gravity has adverse consequences in terms of inherent stability. Therefore, when the multicopter is flying out of ground effect, that is, at higher altitudes, then is could be considered beneficial to move the centre of lift (i.e. the lift structure) upwardly, and preferably above the centre of gravity, so that the stability benefits of having the centre of gravity located below the centre of lift are obtained.

An upper and/or lower part of the fuselage suitably comprises an abutment, which limits the extent of movement of the lift structure relative to the fuselage. This means that the extent of movement up or down can be configured by suitable adjustment of the position of the abutment or abutments. It is envisaged that an upper abutment will be provided at, or towards, the top of the fuselage meaning that the lift structure can be elevated so as to maximise the vertical distance between the centre of lift and the centre of gravity. In addition, a lower abutment or abutments may be provided to prevent the fuselage from separating from the lift structure, for example if it is hoisted by its fuselage.

The multicopter suitably comprises means for driving and/or controlling the movement of the lift structure relative to the fuselage. For example, it is possible for the lift structure to move under its own lifting power, for example by driving the rotors so as to create lift, thereby elevating the lift structure relative to the fuselage. However, it may be preferable, in certain circumstances, to actively control the position of the lift structure relative to the fuselage. This could be accomplished in any number of ways, such as a pulley system operating between the fuselage and lift structure, a rack and pinion configuration operating between the lift structure and the fuselage, and/or by hydraulic/pneumatic means. In other embodiments of the invention, the position of the lift structure relative to the fuselage could be manually-adjustable, for example by providing a set of vertically-offset engagement holes in the fuselage, which a user can lock into with corresponding locking pins of the lift structure.

The multicopter may comprise a plurality of lift structures. By providing a plurality of lift structures, it is possible to provide more rotors, and hence more lift, for a given “footprint”. There are certain efficiency gains to be had by separating one lift structure well above another insofar as the downwash of one lift structure can feed the other. In one possible embodiment of the invention, there is provided a first lift structure located at, or towards a lower part of the fuselage; and a second lift structure located at, or towards, the top of the fuselage. This not only provides redundancy in terms of rotors, but potentially enables smaller, less-expensive motors to be used.

The rotors suitably comprise motor-driven propellers arranged, in use, to direct thrust substantially downwards so as to produce lift. In certain embodiments each motor drives a pair of substantially coaxial propellers, which are axially relative to one another.

In certain embodiments of the invention, each motor drives two or more propellers. This configuration can increase the number of propellers, and hence the amount of lift generated, without adding the weight and complexity of further motors to the structure.

One or more of the rotors may be connected to is respective spar via a pivoting connection, the angle of which being controllable so as to provide vectored thrust for the multicopter. The pivoting connection may be moveable in two or more directions to provide thrust vectoring in fore/aft and/or left/right directions.

By pivotally connecting the rotors to the distal ends of the spars, it is possible to use thrust vectoring to control the orientation and/or direction of travel of the multicopter. Thrust vectoring can be used in addition to, or instead of, controlling the relative speeds of the rotors. Such a configuration usefully enables the multicopter to be driven in different directions without needing to be tilted. Specifically, in the case of a conventional “drone” type aircraft, forward movement is obtained by tilting the whole drone forwards so that the thrust vectors point rearwardly. In an unmanned aircraft, this is perfectly acceptable, as there is no adverse “feeling” associated with travelling in a pitched-forward orientation. However, flying forwards and facing towards the ground may be disconcerting for a human passenger, and if the invention is to be widely adopted as a mass transportation device, this drawback required some consideration. The solution proposed by certain embodiments of the present disclosure is to use a combination of thrust vectoring and propeller speed control to enable a similar movement of the thrust vectors without bodily tilting the multicopter itself. This may enable the multicopter to adapt a more horizontal orientation, whilst the thrust vectors are pointing rearwardly, thereby providing forward thrust. This may ameliorate one or more of the aforesaid adverse implications of simply replicating and/or adapting a known “drone-type” device.

A controller is suitably provided, which is adapted, in use, to convert control inputs of an operator into control outputs for the or each rotor, the control outputs being any one or more of the group comprising: the speed of each rotor, the direction of rotation of each rotor; and the angle of each rotor.

It is envisaged that the multicopter may be controlled by a human occupant operating one or more joystick type devices. This could be a pair of joysticks, one of which controls pitch and roll; and the other one controlling yaw and lift—as will be familiar to drone pilots. Alternatively, yaw might be controlled by a push-button on either side-stick viz. left to turn left and right to turn right. However, other methods may be employed, which are more intuitive to non-pilot users. For example, a display screen may be provided, which enables a user to simply input the destination location on a map, whereupon the multicopter will simply “fly itself” there under computer control. The use of automated and/or computer control is particularly advantageous in heavily-congested areas where collision avoidance and adherence to air traffic patterns/restrictions is required.

The multicopter suitably comprises a cockpit for a human occupant, the cockpit comprising means for supporting the human occupant and one or more controllers, which the occupant can operate, in use, to control the multicopter.

The means of supporting a human occupant could comprise a seat, but as being in a seated position requires a larger footprint area, it is envisaged that an occupant of the multicopter of this disclosure might ordinarily use it in a standing position. This means that the size of the central aperture in which the user stands can be made much smaller, thereby reducing the overall footprint of the multicopter. For example, a “sling” type device could be used which the occupant effectively perches or leans upon, rather than providing a conventional seat, which requires a certain amount of “legroom”.

The rotors are preferably powered by electric motors, and wherein on-board rechargeable batteries are provided for powering the electric motors.

Accordingly the present invention features a novel arrangement which meets the most practical challenges of powered-lift devices at a reasonable cost and using the safest layout of propellers.

Possible embodiments of multicopter, and especially those in accordance with the invention, are illustrated, by way of example only, by the accompanying drawings in which:

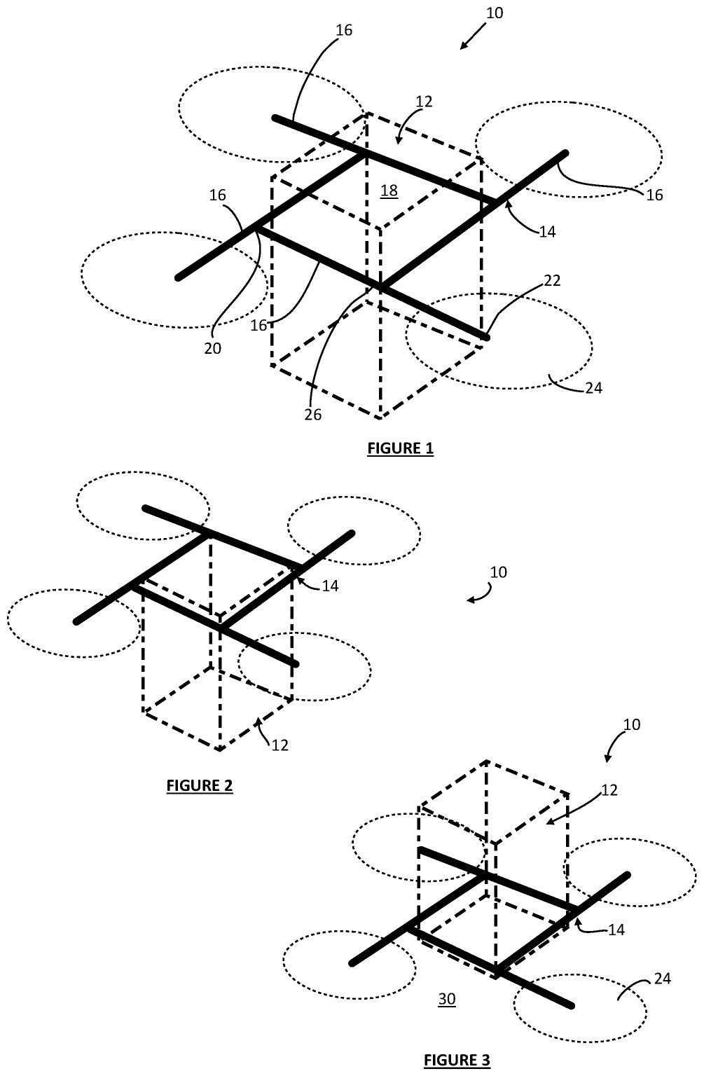

FIG. 1 is a schematic perspective view of a multicopter in accordance with the invention;

FIGS. 2 and 3 are schematic perspective views of the multicopter of FIG. 1 in different configurations;

FIGS. 4 to 7 show different possible octocopter arrangements;

FIG. 8 is a perspective view of a fuselage;

FIG. 9 is a perspective view of the fuselage of FIG. 8 fitted to the lift structure of FIG. 6;

FIGS. 10, 11 and 12 show plan views of different lift structure configurations;

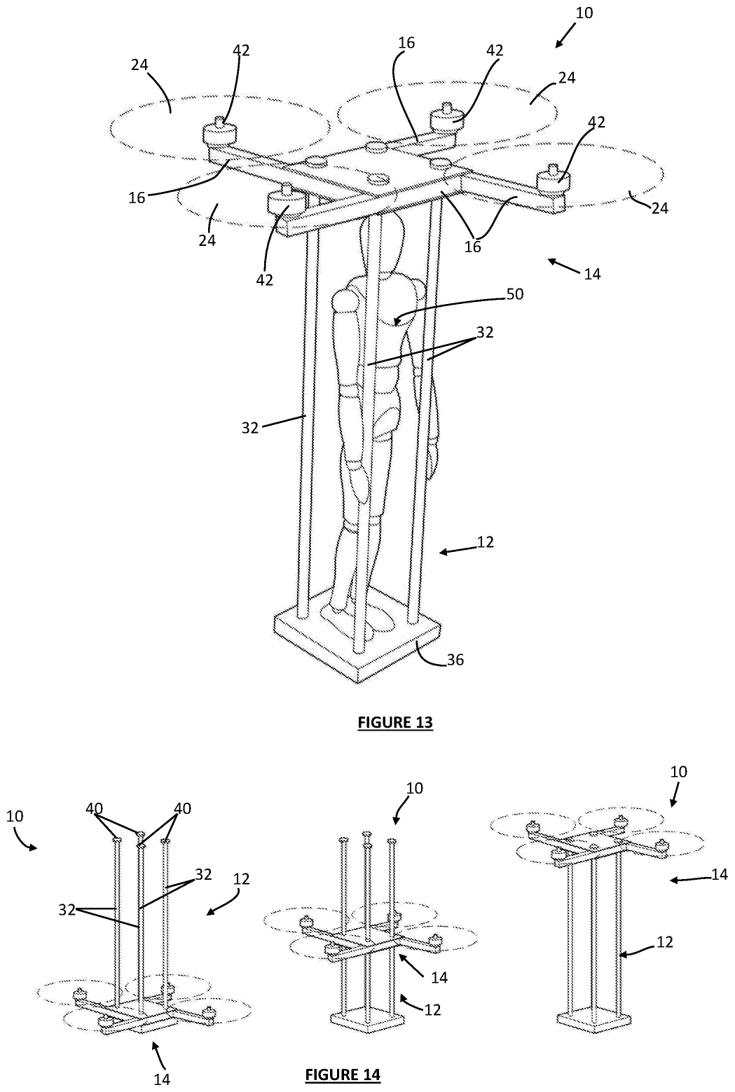

FIG. 13 is a schematic, perspective view of an embodiment of a single-person multicopter in accordance with the invention;

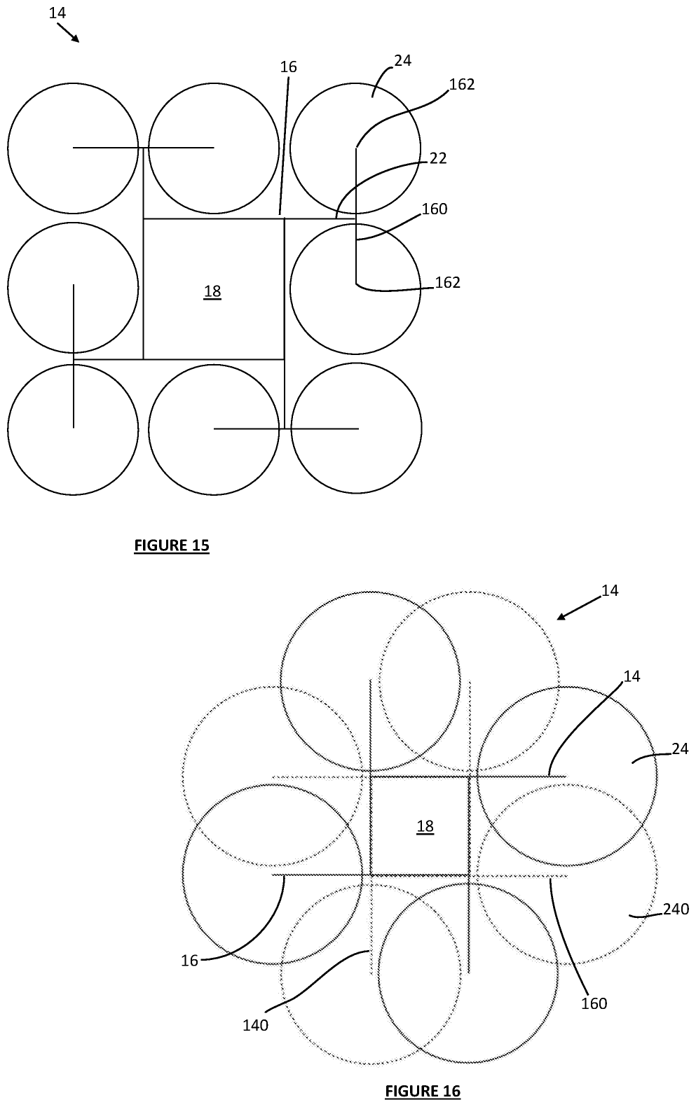

FIG. 14 shows the multicopter of FIG. 13 in different configurations;

FIGS. 15 and 16 show different configurations of the lift structure described herein;

FIG. 17 is schematic, perspective view of another embodiment of a multicopter in accordance with the invention; and

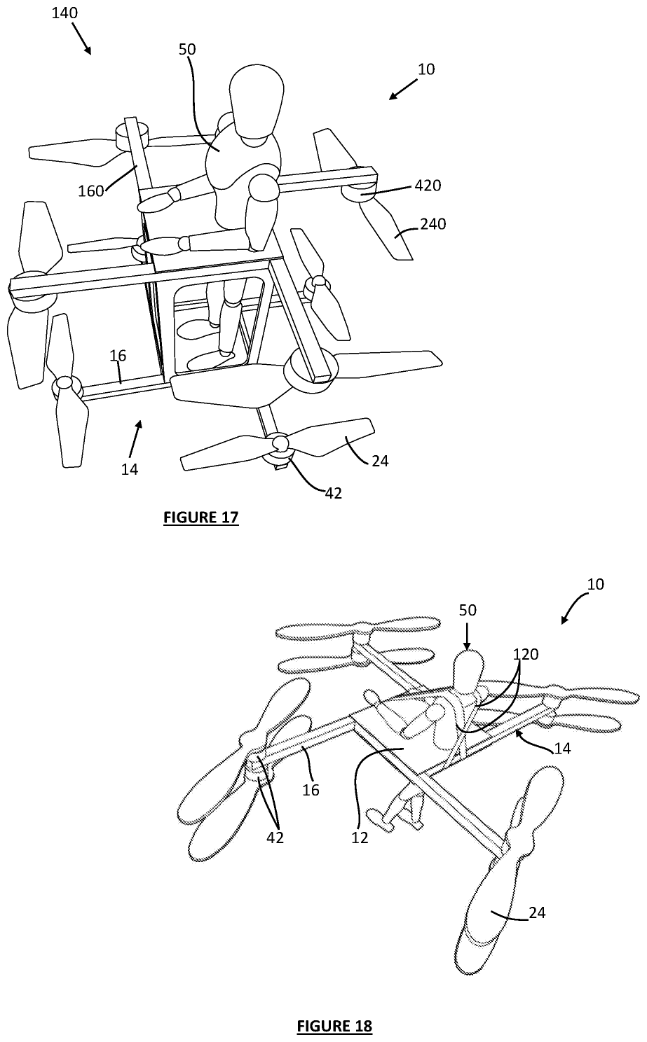

FIG. 18 is schematic, perspective view of yet another embodiment of a multicopter in accordance with the invention.

An embodiment of a multicopter 10 in accordance with the invention is shown, schematically, in FIG. 1 of the drawings. The multicopter 10 comprises a fuselage 12 and a lift structure 14. The lift structure 14 is formed by a set of four spars 16, which are interconnected in such a way that an aperture 18 is formed at the centre of the lift structure 14. Each spar 16 has a root end 20 and a distal end 22. A rotor 24 is mounted at, or near to, the distal end 22 of each spar 16. The root end 20 of each spar connects to a fixing point 26 of another spar 16, the fixing point 26 being located at a point between the root end 20 and the distal end 22 of the said other spar 16. This creates a generally square-shaped aperture 18 at the centre of the lift structure 14 within which, the fuselage 12 is accommodated.

In the illustrated embodiment, the fuselage 12 has a generally cuboidal configuration. The spars 16 therefore project radially outwardly from the fuselage 12/centre aperture 18, thereby spacing the rotors 24 radially outwardly of the fuselage 12.

Turning to FIG. 2 of the drawings, it can be seen that the lift structure 14 is an elevated position relative to the fuselage 12. Here, the centre of lift is located above the centre of gravity of the fuselage 12. Conversely, FIG. 3 of the drawings shows the same multicopter 10, but this time, with the lift structure 14 in a low position relative to the fuselage 12. Here, the centre of gravity of the fuselage is located above the centre of lift. In preferred embodiments of the invention, the location of the lift structure 14 relative to the fuselage is adjustable.

For example, the multicopter 10 can be landed on the ground with the lift structure 14 moved downwardly relative to the fuselage 12 (as shown in FIG. 3). The lift structure 14 thereby forms an undercarriage/supporting base for the multicopter 10. This means that a person can enter the fuselage simply by stepping through/over the rotors 24, rather than having to “duck under” the rotors, if they were in the elevated position (shown in FIG. 2).

In use, the multicopter 10 can lift off the ground 30 by powering-up the rotors 24 to provide a downwash of thrust, which lifts the multicopter 10 off the ground. Initially, the multicopter 10 will be operating in “ground effect”, in which case, it may be advantageous to keep the lift structure 14 as close to the ground as possible, that is to say in the lowered position illustrated in FIG. 3.

However, when the multicopter 10 moves out of ground effect, there may be advantage to be gained by moving the lift structure 14 upwardly relative to the fuselage 12 so that the centre of gravity of the multicopter 10 is now located below the level of the lift structure 14. This renders the multicopter 10 more inherently stable during normal flight, out of ground effect, due to the pendulous effect of the weight of the fuselage 12/payload.

In FIG. 4, a geometric layout is that of an octocopter 10 or eight-legged powered-lift vehicle like that of smaller drones that feature more than four rotors 24 so as to benefit both stability and redundancy.

Note, in particular that for transporting a passenger, that there are effectively two aircraft operating independently from a safety viewpoint, and in parallel from the operational viz. rotors 1, 2, 3, 4 and 5, 6, 7, 8. This means that one set might merely provide power whilst the other combines control motions. This is a common arrangement in fly-by-wire types where one control channel acts as a primary device, and another as a secondary device to take over in the event of a failure.

FIG. 5 shows how the layout is reinforced with a “noughts-and-crosses” arrangement of spars 16 that support the payload. Ideally a parallel pair of spars 16 spans the underside of the platform and the other the other side, and they are joined at their intersections by ties inserted throughout.

FIG. 6 shows in profile view an outline comprising the body of a lifting structure 14 that may be pre-moulded, or else incorporate cut-outs in laminated expanded foamed-plastic sheet for example. Naturally the invention described here suits mounting arrangements for any number of electrically-powered rotors in different geometric arrangements, with those here considered most practical.

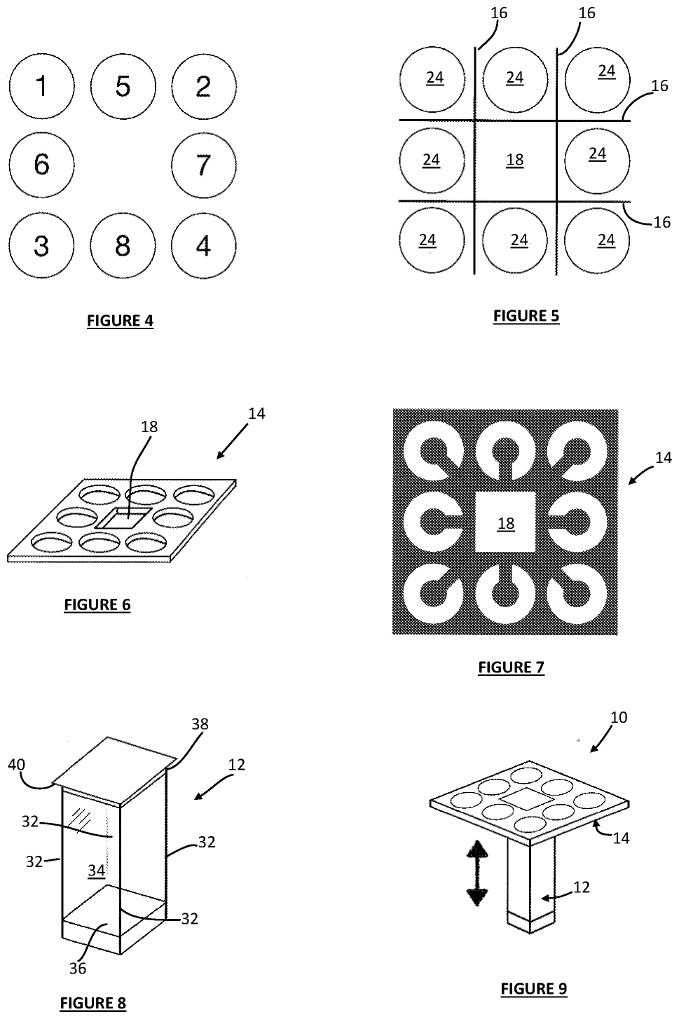

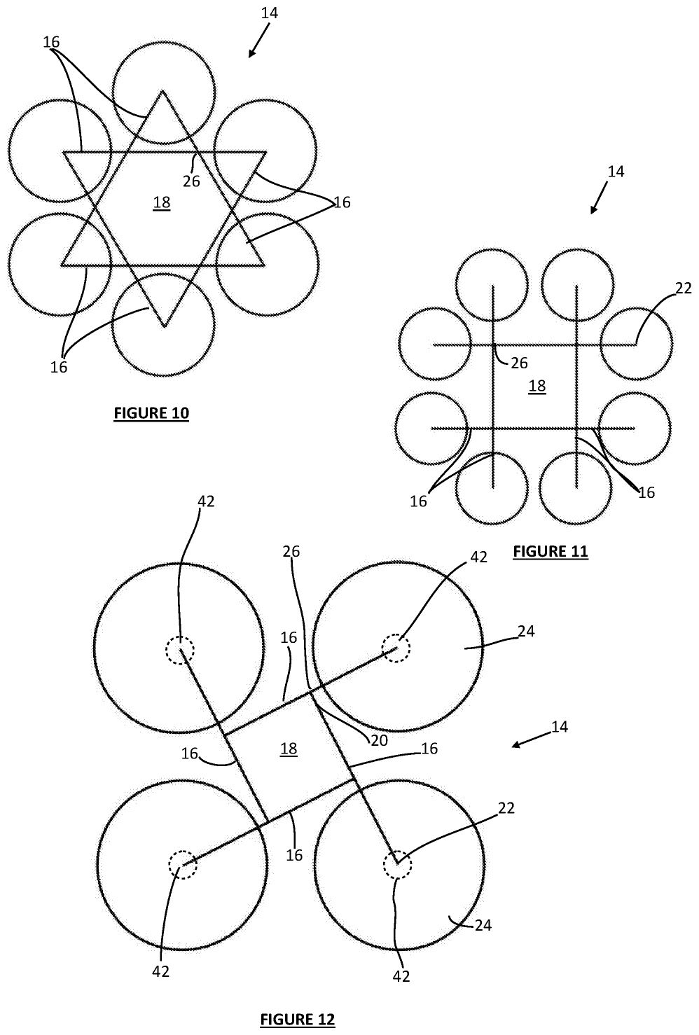

In FIG. 7, a lift structure 14 appears in plan view that underpins the body of the lifting device, and which is typically stiffer and thinner as a means of mounting the motors and dispersing the consequent stresses. The cut-outs form eight holes that contain the diameter of each rotor, and each has a node in the form of a cantilevered axis on which a motor is attached. Motors might be supported at either side, but a cantilevered support is more aerodynamically efficient. The cantilevers that connect the axes of the motors are also a means of routing electrical wiring or control cables.

FIG. 8 features a “fuselage 12 in the form of a transportation booth” that is not unlike a telephone box. In this implementation however a booth 12 of this kind might be three-sided and without a door. In this event it retains structural columns 32 at each corner for integrity but uses polycarbonate screens 34 that form front and side surfaces in flight.

The base 36 of the booth 12 supports a passenger standing upright, beside the heavier components of the aircraft like batteries or other forms of energy storage or generation. Its roof-space 38 contains room for data-processing and/or communications equipment that enable pilot-less operation from one point to another. Above this space the top surface of the booth forms a square capital 40 whose dimensions exceed those of the cut-out 18 in the lift structure 14, so that whilst this may slide up the booth 12, its movement is arrested at the top-most limit 40.

The lift structure 14 is able to climb under power from rest up the sides of the booth 12 so that it engages with the overhang 40 and raise the payload. In its uppermost position, it engages electrical contacts that provide it with power routed from the base of the booth 12, and connects the processing centre to enable it to be steered in flight. In order to rise from the ground in the first instance, the motors have originally to be powered, but because the energy required is minimal this might be provided by independent sources, by a live rail running up the columns 32 of the booth 12, or using a temporary ground electrical supply.

FIG. 9 is a schematic assembly 10 in flight and what is most significant in altering the layout between ground and air is that after occupying the base it forms a rotor-head, optimising the disposition of weight in each case. On the ground the lift structure 14 stabilises the booth 12 so that no undercarriage is required beside four feet; and in flight the lift structure 14 provides a clear view to the operator beside the pendulous stability that so benefits every vertical-lift type.

At the outset, when the passenger boards the machine, the lift structure 14 may be surrounded by a launch-pad whose surface coincides with it so that the area looks like the transporter in an episode of TV series “Star Trek”. Once the rotors or ducted propellers are powered up with passengers aboard, the surface around the booth 12 appears to rise to its uppermost position, whereupon the vehicle 10 is levitated by vertical lift and directed to its its destination in forward flight.

Where flights are restricted to altitudes of ten feet (or three metres) then forms of transport like this need not be certified by civil aviation authorities. To meet these less stringent requirements, the powered platform can be latched in a GROUND position at the lowermost limit (as opposed to FLIGHT setting at its uppermost) to confine the vehicle 10 to ground-effect and restrict the operation.

FIGS. 10, 11 and 12 show various novel arrangements of spars 16 that both support any number of motors 24 and allow for a transportation booth 12 or capsule to be incorporated within the arrangement in the ways described hereinbefore.

FIGS. 10 and 11 are novel in that they might comprise two separate modules that can be fitted to such means and used in conjunction viz. two quad-rotors set at right-angles in the second instance and two triangular arrangements of rotors in the first. Nonetheless, either of these multiple configurations provides ample redundancy in the event of failure.

An especially efficient arrangement of rotors appears in FIG. 12, where thrust supporting the vehicle 10 is maximised whilst its outline remains compact. Such rotors 24 could be used in shrouded or open configurations, and arranged to overlap themselves or the transportation booth 12 itself, especially in instances where its components are fixed in position. (Even used in this way however the benefits of offloading the power supply and/or processors and communication systems to the booth 12 are considerable and while it is offset, computerised control allows it to be steered normally.).

The dimension of the square 18 in FIGS. 11 to 12 is suitably 24 inches and the diameter of rotors are suitably 42″ respectively, highlighting the improved swept efficiency of the latter embodiment over the previous ones.

FIG. 13 illustrates a prototypical outline of a multicopter 10 according to the invention in which it can be seen that capitalises on the configuration featured in FIG. 12. The advantage of this is principally that four spars 16 need not be overlain or lap-jointed, but simply abutted in an array and fixed for example by plates. As seen here, each of the spars 16 comprises aluminium sections typically 50 mm square and 1500 mm in length in order that the central aperture is about half of their length (i.e. about 750 mm square).

The lift structure, cassette or rotor-head assembly 14 is thus able to support electrical motors 42 and rotors 24 of say 28″ or 30″ in diameter that might be doubled up one above another per conventional practise, or else the lower set of four for example might be of a different diameter with motors of different power ratings. The spars 16 are also used to route the wiring from the central area, which may contain any combination of control and communications equipment beside energy sources.

For maximum structural integrity, a four-square assembly of columns 32 is fixed in place so as to provide a form of booth for the passenger or operator 50, and whilst this framework 32 may be left open, the addition of Perspex or polycarbonate screens (not shown) that form sides and/or doors serves to act as a set of shear-webs that reinforce the structure generally beside adding to its appearance.

The base 36 might contain batteries of electrical power ideally, so that the mass of these stabilise the aircraft 10 both on the ground and in the air, with power sourced from these to the equipment within the rotor-head. Alternatively, all such equipment might be stored in this base 36 whilst only a back-up set for instance is retained at uppermost.

A feature of the base 36 here is that its construction mirrors the assembly at the upper end of the aircraft 10 except that the beams that form the spars 16 are truncated. They could of course be left to some extent or another either to stabilise the vehicle on the ground, or indeed to support a further set of motors 42 and rotors 24 that contra-rotate as compared to the upper set.

Beside an additional source of thrust, a lower set of power units 42, 24 optimises use of the aircraft 10 in ground effect.

The lift structure 14 or rotor head is fixed here by columns 32 which perforate upper and lower plates within each of the corners framed by the spars 16, and which terminate in stops 40 or fasteners. Circular tube sections (not shown) inside this space act as guides for the columns 32, to the extent that in different embodiments the entire rotor-head assembly 14 is able to move freely under its power from around the base 36 and up to those stops 40, so as to further stabilise the structure 10 whilst at rest.

FIG. 14 shows the sequence of raising and lowering a lift structure 14 guided by columns 32, the upper ends of which might be located by a shim 40 in the absence of the rotor-head, for example whilst it lies near the ground. From the foregoing, it is apparent that the base 36, columns 32, rotor-head/lift structure 14 and whichever sides or doors that might fitted—may be detachable to allow delivery, assembly or disassembly and storage in a plat-pack format.

FIG. 15 of the drawings shows a variation of the arrangement of spars 16 of the lift structure 14 shown in FIGS. 1-3 and 12. Here, each distal end 22 of each spar 16 carries a T-shaped end piece 160, which bifurcates the distal end 22 of each spar 16. Each end piece 160 has two free ends 162, each of which supports a motor (not shown), which drives a respective rotor 24. The main advantages of this configuration include additional redundancy (octocopter vs quadcopter); as well as a greater swept area for a given overall footprint, compared with the embodiment shown in FIG. 12, for example.

FIG. 16 of the drawing shows a stacked lift structure configuration, in which there are two similar or identical lift structures 14, 140, which are vertically spaced apart from one another. Here, the lower lift structure 14 (shown in solid lines) is rotated by 90-degrees relative to the upper lift structure 140 (shown in broken lines). This configuration also provides additional redundancy (octocopter vs quadcopter); as well as a greater swept area for a given overall footprint, compared with the embodiment shown in FIG. 12, for example.

FIG. 17 of the drawing shows, in perspective, an embodiment of a multicopter 10 in accordance with the invention, which has a pair of vertically spaced-apart lift structures 14, 140, which are interconnected by a set of vertical columns 32 forming a fuselage 12 within which an operator 50 stands. The lower lift structure 14 is aligned with the base 36 of the fuselage 12, which base 32 houses the batteries required to drive the motors 42, 420, as well as control circuitry, etc. Each lift structure 14, 140 is formed for a respective set of four beams 16, 160 which are configures, as described herein to leave an open aperture 18 at the centre. The aperture 18 of the upper lift structure 140 enables the operator 50 to stand within the fuselage structure. As the operator 50 is standing, the overall footprint of the multicopter 10 is relatively small as the size of the central aperture 18 does not need to be more than about 50-60 cm×50-60 cm. The operator 50 can control the multicopter manually, or using fly-by-wire technology, which is the preferred option.

A yet further possible embodiment of the invention is shown in FIG. 18 of the drawings, which is a simplification of the embodiment shown in FIG. 17. Here, there is only one lift structure 14, which is effectively “worn” by the operator 50 via a harness-type arrangement, the harness-type arrangement being the “fuselage” of this embodiment. Whilst this may initially appear somewhat alarming, those familiar with recreational airsports, such as paragliding or sub-80 kg, single-seat deregulated (SSDR) microlighting, will appreciate the benefits in terms of weight reduction, simplicity etc. that can be obtained by lightweight, “wearable” aircraft.

Each lift structure 14 of the embodiment shown in FIG. 18 is optimised for performance especially as regards weight, with an operator supporting the vehicle with straps 120 around the shoulders whilst at rest and the vehicle supporting the operator around the seat when airborne. The outline is easily adapted to appear like the previous embodiments by enclosing the operator in open-ended boxes, one above the chassis and one below, that might retain say the conventional appearance of a telephone booth.

Ideally, the chassis might encapsulate a central hole 18 which the operator 50 steps into whilst the drive-train/lift structure 14 rests on the ground, and is pulled or powered up to elbow height from whence shoulder and crotch straps might be attached. The operator 50 might also stand at forty-five degrees to the outline so as to maximise the allowable space (i.e. diagonally within the central aperture 18). In order to lighten the vehicle 10 to the greatest extent beside this, all of the working components of the multicopter 10, aside from the motors 42 and rotors 24 might be worn by the operator 50 viz. batteries, plus control and communications equipment and connected as the framework of the multicopter 10 reaches the operating height. In order to levitate that framework however an independent power source might be utilised.

To maximise the efficiency of rotors 24 an arrangement like that seen in FIG. 16 can be used, which largely removes a lower set of rotors from the downwash of an upper. In order to contrive such an arrangement one four-pronged rotor assembly is inverted relative to the other and stacked one on top of the other, which offsets the assemblies vertically so that each set of rotors is overlapped.

1. A multicopter comprising:
a fuselage; and
a pair of vertically spaced-apart lift structures,
each being formed from four or more spars arranged so as to define a central aperture,
rotors which provide thrust and/or lift for the multicopter located at distal ends of the spars, characterised the lift structures being vertically interconnected by a set of vertical columns and/or sides forming the fuselage;
the fuselage comprising a base for supporting an operator and which closes the aperture of the lower lift structure; and by
the lower lift structure being aligned with the base of the fuselage.

2. (canceled)

3. The multicopter of claim 1, wherein the lift structure comprises four spars, which are arranged at right angles to one another.

4. The multicopter of claim 1, wherein the aperture comprises a substantially square-shaped aperture defined by the spar sections of each spar located between a root end and a fixing point of each spar.

5. The multicopter of claim 1, wherein the aperture comprises a substantially rectangular-shaped aperture defined by the spar sections of each spar located between a root end and a fixing point of each spar.

6. The multicopter of claim 1, wherein the fuselage is located within the aperture.

7. The multicopter of claim 6, wherein the fuselage has a substantially prismatic shape whose substantially constant cross section nests within the aperture, and wherein the lift structure is moveable relative to the fuselage between lower and upper positions.

8. The multicopter of claim 7, wherein an upper and/or lower part of the fuselage comprises an abutment, which limits the extent of movement of the lift structure relative to the fuselage.

9. The multicopter of claim 7, comprising means for driving or controlling or a combination thereof, the movement of the lift structure relative to the fuselage.

10. (canceled)

11. The multicopter of claim 1, wherein the rotors comprise motor-driven propellers arranged, in use, to direct thrust substantially downwards so as to produce lift.

12. The multicopter of claim 11, wherein each motor drives a pair of substantially coaxial propellers, which are vertically axially relative to one another.

13. The multicopter of claim 12, wherein one or more of the rotors is connected to is respective spar via a pivoting connection, the angle of which is controllable so as to provide vectored thrust for the multicopter.

14. The multicopter of claim 13, wherein the pivoting connection is moveable in two or more directions to provide thrust vectoring in fore/aft and left/right directions.

15. The multicopter of claim 1, further comprising a controller, which is adapted, in use, to convert control inputs of an operator into control outputs for the or each rotor, the control outputs being any one or more of the group comprising: the speed of each rotor, the direction of rotation of each rotor; and the angle of each rotor.

16. The multicopter of claim 1, wherein the fuselage comprises a cockpit for a human occupant, the cockpit comprising means for supporting the human occupant and one or more controllers, which the occupant can operate, in use, to control the multicopter.

17. The multicopter of claim 1, wherein the rotors are powered by electric motors, and wherein on-board rechargeable batteries are provided for powering the electric motors.

18. The multicopter of claim 1, wherein the distal end of each spar comprises a T-piece, the distal ends of the T-piece each supporting a rotor.

19. (canceled)

20. The multicopter of claim 1, wherein the aperture of the upper lift structure enables the operator to stand wholly or partially within the fuselage structure.

21. The multicopter of claim 1, wherein the upper lift structure is aligned with the top of the fuselage.

22. The multicopter of claim 1, wherein the length of the vertical columns and/or the height of the sides forming the fuselage is such that the upper lift structure is located substantially at waist height of an operator standing on the base and within the aperture of the upper lift structure.

23. The multicopter of claim 1, wherein each spar comprises a root end opposite to the distal end, the four or more spars being interconnected such that the root end of a first one of the spars is fixed relative to a fixing point of another spar, which fixing point is located between the root end and the distal end of the said other spar.
